(19) United States
(12) Patent Application Publication
(10) Pub. No.: US 2019/0154141 A1
(43) Pub. Date: May 23, 2019

(54) Driver Interface For Shift-By-Wire Transmission

(71) Applicant: Ford Global Technologies, LLC, Dearborn, MI (US)

(72) Inventor: Terry Richard Reames, Livonia, MI (US)

(21) Appl. No.: 16/180,278

(22) Filed: Nov. 5, 2018

Related U.S. Application Data
(60) Provisional application No. 62/589,860, filed on Nov. 22, 2017.

(51) Int. Cl. F16H 59/08; F16H 59/12; F16H 61/24; F16H 61/18; F16H 63/42

(52) U.S. Cl. CPC F16H 59/08; F16H 59/12; F16H 61/24; F16H 2063/423; F16H 63/42; F16H 2059/081; F16H 2061/247; F16H 61/18

(57) ABSTRACT

A family of transmission driver interfaces utilize a rotary knob for selecting among Park, Reverse, Neutral, Drive, and Low transmission modes. These driver interfaces obviate the need for a knob brake or knob motor to support features such as brake interlock and an auto-park. Brake interlock prevents shifting out of Park without depressing a brake pedal. Auto-park changes the transmission state to Park in response to conditions other than driver requests. Some of the driver interfaces use a button in addition to the rotary knob. In some of the driver interfaces, the knob may be rotated indefinitely without encountering a stop.

### CROSS-REFERENCE TO RELATED APPLICATIONS

This application claims the benefit of U.S. provisional application Ser. No. 62/589,860 filed Nov. 22, 2017, the disclosure of which is hereby incorporated in its entirety by reference herein.

### TECHNICAL FIELD

This disclosure relates to the field of automotive automatic transmission systems. More particularly, the disclosure pertains to driver interface features for selecting and displaying a transmission drive range.

### BACKGROUND

Automobiles operate at a wide variety of speeds, including forward and reverse movement. Internal combustion engines, on the other hand, operate efficiently in a limited speed range. Consequently, transmissions are employed to adjust a speed and torque ratio between an internal combustion engine crankshaft and vehicle wheels. Automatic transmission typically provide several driver selectable drive modes including park, reverse, neutral, drive, and low. In park mode, the drive wheels of the vehicle are held stationary. In neutral, the drive wheels are permitted to rotate but no power is transmitted from the engine to the wheels. In reverse, engine power is transmitted to the wheels at a negative speed ratio propelling the vehicle backwards. In drive, engine power is transmitted to the wheels at positive speed ratios propelling the vehicle forward. The transmission changes the positive speed ratio to match current vehicle speed and power demand. When the vehicle is coasting, such as descending a hill, power may or may not be transmitted to the engine to provide engine braking. Low is an alternative forward driving mode suitable for descending grades. In low, the transmission is configured to transmit power in either direction to ensure that engine braking is available.

A driver controls the mode by manipulating some sort of shift selector, such as a steering column lever or a console mounted lever. In some vehicles, the shift selector is mechanically linked to a manual valve in the transmission valve body. The hydraulic control system then selects between reverse, neutral, drive, and low based on the position of the manual valve. In these vehicles, the parking mechanism is also mechanically linked to the shift selector. A shift-by-wire system, in contrast, does not include mechanical linkages between a shift selector, manual valve, and park mechanism. The shift selector communicates the selected drive mode to a transmission controller electronically. The transmission controller then selects an appropriate transmission ratio (or neutral) and engages or disengages the park mechanism accordingly.

To prevent unintentional vehicle movement, vehicles are often equipped with a park-brake-interlock feature. This feature precludes transitioning from park mode unless the brake pedal is pressed.

### SUMMARY

A vehicle includes a transmission, a rotary shift selector knob, and a controller. The transmission has at least a park mode and a reverse mode. The controller is programmed to shift from the park mode to the reverse mode in response to the knob being rotated from a first position to a second position, and, in other conditions, in response to the knob being rotated from the second position to a third position. The controller may also be programmed to shift from the reverse mode to the park mode without rotation of the knob. In some embodiments, the controller may be programmed to shift from the reverse mode to the park mode in response to activation of a park button. In some embodiments, the knob has a plurality of detent positions and is free to move among the detent positions without stops. Some embodiments may include a plurality of symbols in fixed positions around the knob, each corresponding to a transmission mode and configured to indicate whether the transmission is presently in the corresponding transmission mode.

A vehicle includes a transmission, a rotary knob, a select button, and a controller. The transmission has at least a reverse mode and a drive mode. The controller is programmed to shift from the reverse mode to the drive mode in response to selection of drive with the knob followed by activation of the select button, and to shift from the drive mode to the reverse mode in response to selection of reverse with the knob followed by activation of the select button. In some embodiments, the knob has a plurality of detent position and is free to move among the detent positions without stops. In these embodiments, selection of reverse and drive with the knob comprises rotating the knob until symbols corresponding to reverse and drive respectively are illuminated. The controller may also be programmed to shift from the reverse mode or the drive mode to a park mode in response to selection of park with the knob followed by activation of the select button, and to shift from the park mode in response to activation of the select button while a brake pedal is pressed.

A vehicle includes a transmission, a continuous rotary shift selector knob, a plurality of symbols, and a controller. The transmission has at least park, reverse, neutral, and drive modes. The continuous rotary shift selector knob has a plurality of detent positions without stops. The plurality of symbols are in fixed positions, each corresponding to a transmission mode and configured to indicate whether the transmission is presently in the corresponding transmission mode. The controller is programmed to shift the transmission among the reverse, neutral, and drive modes in response to rotation of the knob. In some embodiments, the controller may wait to shift the transmission among the park, reverse, neutral, and drive modes until a select button is pressed. In some embodiments, the controller may be further programmed to shift the transmission from the reverse, neutral, or drive modes to the park mode in response to depression of a park button.

### BRIEF DESCRIPTION OF THE DRAWINGS

FIG. 1 is a schematic diagram of a vehicle powertrain.

FIG. 2 depicts a first shift selector.

FIG. 3 is a flow chart for an auto-park feature.

FIG. 4 depicts a second shift selector.

FIG. 5 is a flow chart for a method of selecting a transmission mode based on manipulation of the second shift selector.

FIG. 6 depicts a third shift selector.

FIG. 7 is a flow chart for a method of selecting a transmission mode based on manipulation of the third shift selector.

FIG. 8 depicts a fourth shift selector.

FIG. 9 is a flow chart for a method of selecting a transmission mode based on manipulation of the fourth shift selector.

FIG. 10 depicts a fifth shift selector.

FIG. 11 depicts a sixth shift selector.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

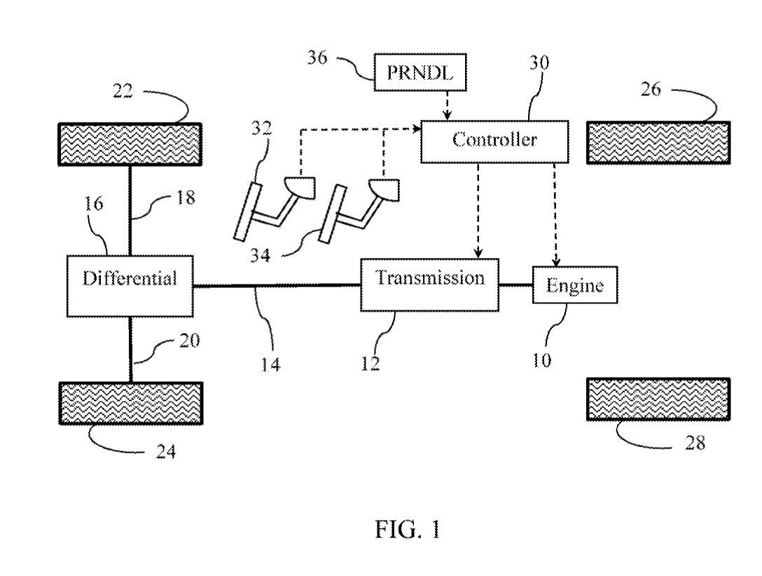

FIG. 1 schematically illustrates a rear wheel drive vehicle powertrain. Power is provided by internal combustion engine 10. Transmission 12 adjusts the speed and torque of the engine crankshaft based on vehicle speed and driver power demand. Driveshaft 14 connects the transmission output to differential 16 which divides the power between left and right half-shafts 18 and 20. Half-shafts 18 and 20 drive rear wheels 22 and 24 respectively. Front wheels 26 and 28 are not powered. Controller 30 provides control signals to engine 10 and transmission 12. Controller 30 receives input signals from accelerator pedal 32, brake pedal 34, and shift selector 36 to ascertain driver intentions. Controller 30 may be a single microprocessor or multiple communicating processors. Shift selector 36 may take several different forms as discussed below. A front wheel drive vehicle has similar components except that the front wheels are powered as opposed to the rear wheels. The driver interface features described herein are applicable to rear wheel drive, front wheel drive, all-wheel drive, and four-wheel drive vehicles as well as vehicles having fewer than four or more than four wheels.

FIG. 2 illustrates a first shift selector. Rotary knob 40 is located within the drivers reach and vision such as on a dashboard. The letters P, R, N, D, and L (42, 44, 46, 48, and 50), or other suitable symbols denoting corresponding driving modes, are printed on a fixed surface around the rotary dial 40. Some embodiments may have multiple low modes and/or may designate these modes with letters other than L. A feature, such as line 52, is fixed to the rotary knob. The knob may have detent positions corresponding to each drive mode such that the feature points to the corresponding letter when the knob is in the corresponding detent position. A position sensor, not shown, communicates the current rotational position of the knob to the transmission controller.

To implement the park-brake-interlock, a knob brake, not shown, holds the knob stationary in response to a signal from the controller. The controller engages the knob brake whenever the knob is in the park position and the brake pedal is not pressed. The controller releases the knob brake whenever either the transmission is not in park mode or the brake pedal is pressed.

Some vehicles may include another safety feature in which the transmission controller selects park in response to conditions other than driver movement of the shift selector. For example, to prevent vehicle movement when a driver accidentally forgets to select park before exiting the vehicle, the controller may select park in response to the release of the brake pedal with the driver door open and the driver seatbelt not being fastened. As another example, the controller may select park when the ignition is turned off. In these vehicles, additional hardware may be required to synchronize the shift selector with the current transmission mode. For example, a motor may be provided to rotate the knob based on commands from the controller. Whenever the controller transitions to park mode for any reason other than a driver command via the shift selector, the controller commands the motor to position the knob to the park position.

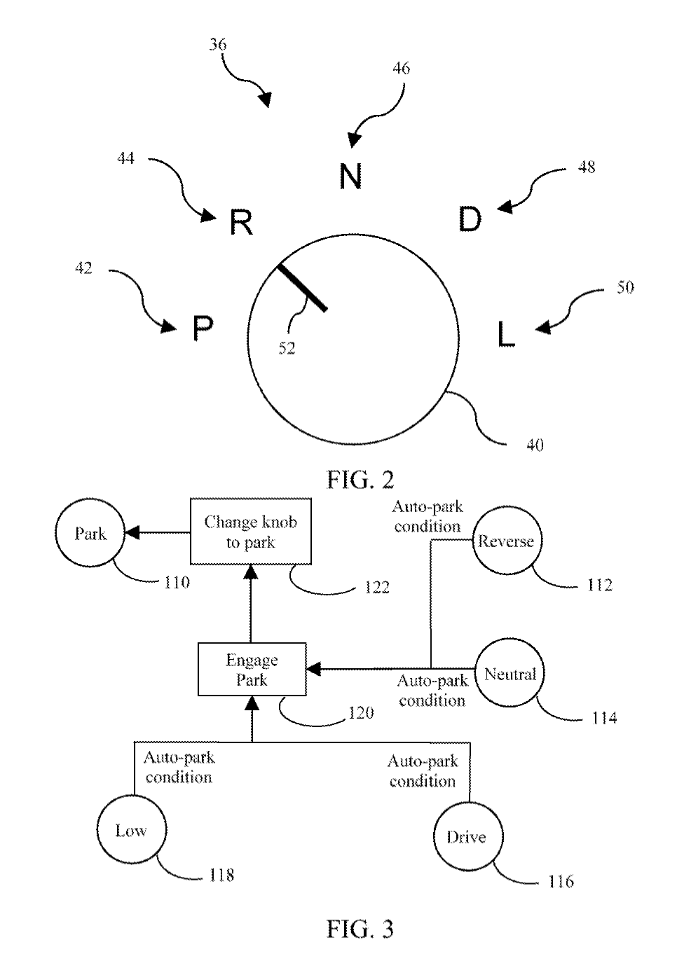

FIG. 3 is a flow chart for an auto-park feature. States are represented by circles. At any given moment, the controller is in one state such as Park 110, Reverse 112, Neutral 114, Drive 116, or Low 118. The controller leaves a state and executes other actions based on events, possibly ending in a different state. In the flow chart of FIG. 3, the controller exits states 112-118 in response to an auto-park event. As discussed above, an auto-park event may be triggered by, for example, the ignition being turned off In response to an auto-park event while in states 112-118, the controller engages park at 120, synchronizes the shift selector at 122, and then enters Park state 110. With the shift selector of FIG. 2, synchronizing the shift selector requires physically turning knob 10 which requires a motor.

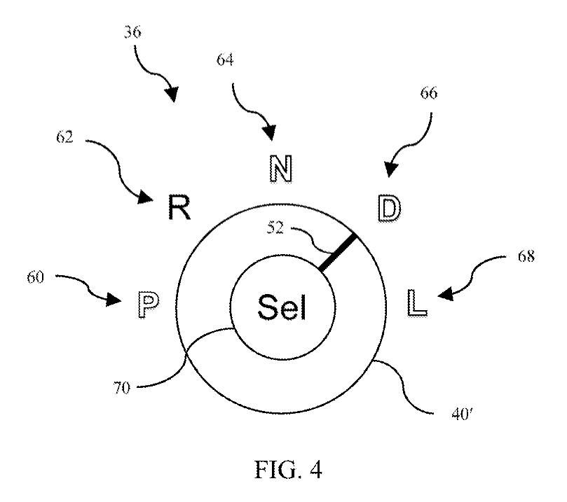

FIG. 4 illustrates a second shift selector. Rotary knob 40′ has five detent positions corresponding to park, reverse, neutral, drive, and low. Letter shaped lights 60, 62, 64, 66, and 68 are fixed to a surface around the rotary dial 40′. Feature 52 points to the letter corresponding to the current position. A sensor sends a signal to the controller indicating which of the five detent positions the knob currently occupies. Select button 70 is located in the center of knob 40′. Alternatively, select button 70 may be located adjacent to the knob. The button sends a signal to the controller indicating when the button is pressed. The controller illuminates only the light corresponding to the presently selected mode. Note that the presently selected mode does not necessarily correspond to the current position of knob 40′ as indicated by feature 52. For example, in FIG. 4, the letter R 62 is illuminated to indicate that the transmission is in reverse while the knob points to the letter D 66. Alternatively, the letters themselves may be non-illuminated and a light may be placed near the letter to indicate the currently selected mode.

To change modes, the driver first rotates knob 40′ such that indicator 52 points to the desired mode. Then, the driver presses the select button. The controller does not respond directly to rotation of knob 40′. In response to activation of select button 70, the controller shifts to the mode indicated by knob 40′, unless some condition inhibits that transition. For example, if the transmission is currently in park and the indicator points to D, the controller would respond to activation of the select button 70 by checking the state of the brake pedal. If the brake pedal is depressed, the controller would shift to drive and illuminate the D button 66. If the brake pedal is not depressed, the controller would ignore the activation of the select button, stay in park, and maintain the letter P 60 illuminated.

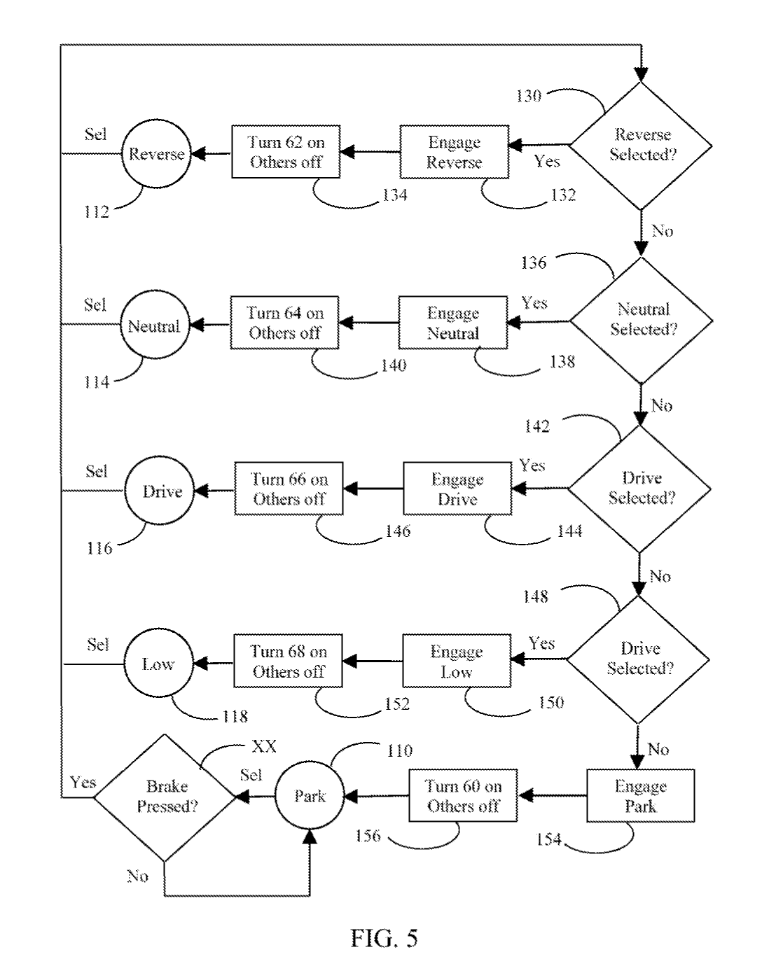

FIG. 5 is a flow chart for use of the shift selector of FIG. 4. When the controller is in any of states 112-118, the controller responds to an Sel event which is triggered by the driver pressing Select button 70. The controller checks at 130 whether knob 40′ is in the reverse position. If so, the controller commands the transmission to engage reverse at 132, updates the display LEDs at 134, and enters Reverse state 112. If knob 40′ is in the neutral position at 136, the controller commands the transmission to engage neutral at 138, updates the display LEDs at 140, and enters Neutral state 114. If knob 40′ is in the drive position at 142, the controller commands the transmission to engage drive (1st gear) at 144, updates the display LEDs at 146, and enters Drive state 116. If knob 40′ is in the low position at 148, the controller commands the transmission to engage low (M1) at 150, updates the display LEDs at 152, and enters Low state 118. If knob 40′ is not in the reverse, neutral, drive, or low positions, the controller concludes that it must be in the park position, commands the transmission to engage park at 154, updates the display LEDs at 156, and enters Park state 110. From Park state 110, the controller responds to a Sel event by checking whether the brake pedal is pressed at 158. If so, it follows the same logic as a Sel event from states 112-118. If the brake is not pressed at 158, the controller remains in state 110.

The controller may execute the flow charts of FIGS. 3 and 5 simultaneously. With the shift selector of FIG. 4, the synchronization at 122 in FIG. 3 is accomplished by illuminating LED 60 and extinguishing the other LEDs. Knob 40′ is not physically rotated, so no motor is required.

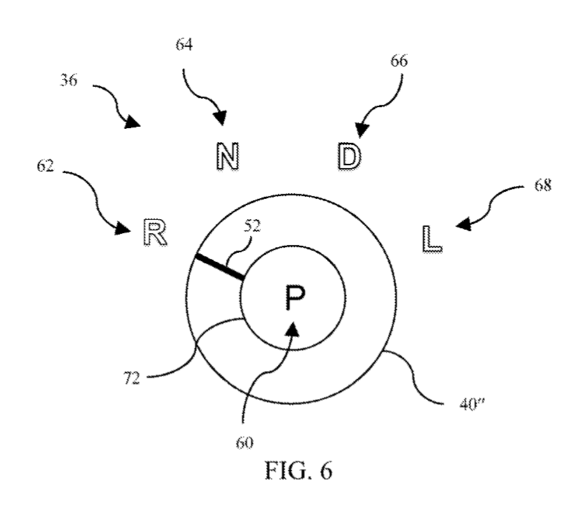

FIG. 6 illustrates a third shift selector. Rotary knob 40″ has four detent position corresponding to reverse, neutral, drive, and low. Letter shaped lights 62, 64, 66, and 68 are fixed to a surface around the rotary dial 40″. Feature 52 points to the letter corresponding to the current position. A sensor sends a signal to the controller indicating which of the four detent positions the knob currently occupies. Park button 72 is located in the center of knob 40″. Alternatively, knob 40″ may move axially to also function as a push button. The button sends a signal to the controller indicating when the button is pressed. The light for park 62 is located within the park button. The controller illuminates only the light corresponding to the presently selected mode.

When the transmission is not in park, the controller shifts among reverse, neutral, drive, and low in direct response to driver rotation of knob 40″. To shift into park, the driver presses the park button 72. Various options are possible for exiting park. In some embodiments, park button 72 may act like the select button of the previous example. In other examples, the controller may respond to movement of the knob 40″ by shifting to the newly selected mode if the brake is pressed. In either case, the controller will not leave the park state unless the brake pedal is pressed. If the transmission shifts into park for some reason other than the driver pressing the park button, the P light 62 is illuminated, the other lights are extinguished, and the system operates as described above. With the shift selectors of FIGS. 4 and 6, a knob brake is not required in order to implement the park-brake-interlock feature, since the park-brake-interlock feature is implemented by ignoring button presses. Similarly, no motor is required to rotate the motor to maintain synchronization between the knob position and the current mode selection, since the current mode selection is indicated by illuminating lights and is not expected to necessarily correspond to the knob position.

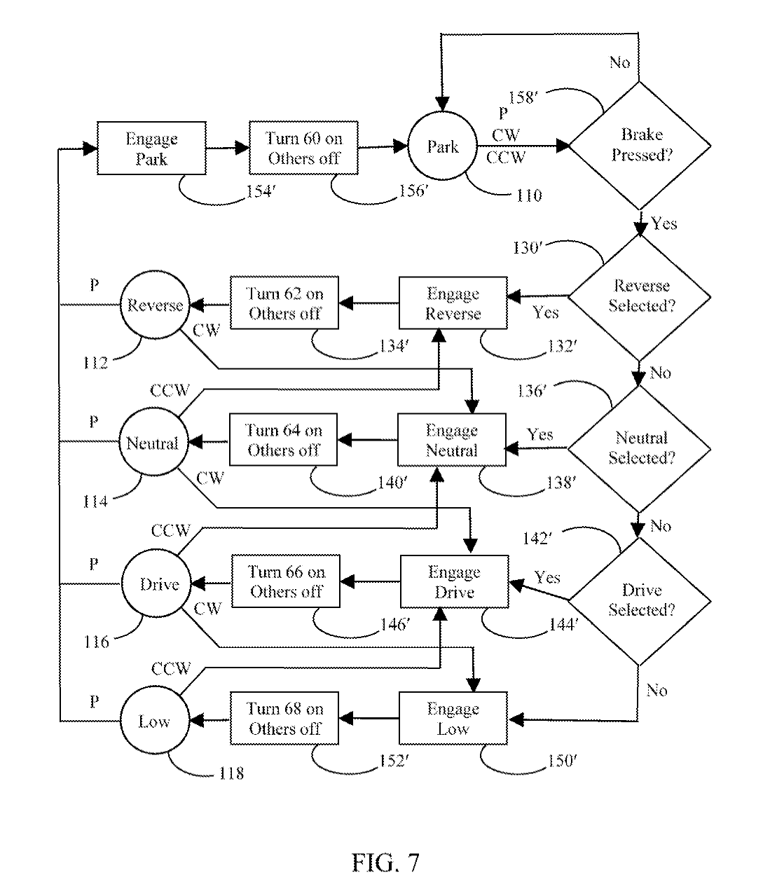

FIG. 7 is a flow chart for use of the shift selector of FIG. 6. When the controller is in any of states 112-118, the controller responds to a P event, which is triggered by the driver pressing Park button 72, by commanding the transmission to engage park at 154′, updating the display LEDs at 156′, and entering the park state. From the Park state 110, the controller responds to various events as described for various embodiments as described above. Some embodiments may only respond to P events. Other embodiments only respond to CW and CCW events, which are triggered by clockwise and counter-clockwise rotation of knob 40″ respectively. Other embodiments may respond to all of these event types. The controller checks at 158′ whether the brake pedal is pressed. If not, the controller remains in Park state 110 without shifting the transmission. If knob 40″ is in the reverse position at 130′, the controller commands the transmission to engage reverse at 132′, updates the display LEDs at 134′, and enters Reverse state 112. If knob 40” is in the neutral position at 136′, the controller commands the transmission to engage neutral at 138′, updates the display LEDs at 140′, and enters Neutral state 114. If knob 40″ is in the drive position at 142′, the controller commands the transmission to engage drive at 144′, updates the display LEDs at 146′, and enters Drive state 116. If knob 40′ is not in the reverse, neutral, or drive positions, the controller concludes that it must be in the low position, commands the transmission to engage low at 150′, updates the display LEDs at 152′, and enters Low state 118.

From Reverse state 112, the controller responds to a CW event by engaging neutral at 140′, updating the display LEDS at 142′, and entering Neutral state 114. The controller takes these same steps in response to a CCW event from Drive state 116. From Neutral state 114, the controller responds to a CCW event by engaging reverse at 132′, updating the display LEDS at 134′, and entering Reverse state 112. The controller takes these same steps in response to a CCW event from Drive state 116. The controller responds to a CW event in Neutral state 114 by engaging drive at 146′, updating the display LEDS at 148′, and entering Drive state 116. The controller takes these same steps in response to a CCW event from Low state 118. From Drive state 116, the controller responds to a CW event by engaging low at 150′, updating the display LEDS at 152′, and entering Low state 118.

The controller may execute the flow charts of FIGS. 3 and 7 simultaneously. With the shift selector of FIG. 6, the synchronization at 122 in FIG. 3 is accomplished by illuminating LED 60 and extinguishing the other LEDs. Knob 40″ is not physically rotated, so no motor is required.

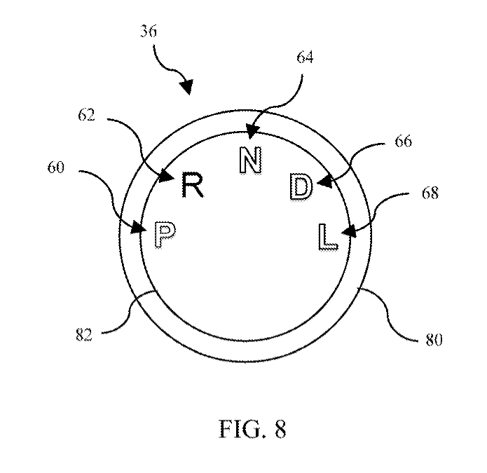

In the shift selectors of FIGS. 2, 4, and 6, the knob rotates through less than 360 degrees and has a predefined number of detent positions. The controller responds to the current position of the knob. FIG. 8-11 illustrate shift selectors that use a continuous knob that does not have stops. The controller responds to changes in position of the knob as opposed to responding to the current absolute position. The knob does not include any feature indicating a current position.

FIG. 8 illustrates a fourth shift selector. Continuous rotary knob 80 is located within the drivers reach and vision such as on a dashboard. Letter shaped lights 60, 62, 64, 66, and 68 are fixed to a non-rotating surface 82 around which knob 50 rotates. Alternatively, the letter shaped lights may be arranged around the perimeter of knob 50 similarly to FIGS. 2, 4, and 6. The shape of each light corresponds to the available transmission modes. The controller illuminates only the light corresponding to the presently selected mode. In FIG. 8, the letter R 62 is illuminated indicating that the transmission is in reverse. The knob has a set of detent positions which are preferably spaced equally and separated by approximately the same angle as the angular separation between the letter shaped lights. The number of detent positions may exceed the number of available transmission modes. The knob is movable through multiple full rotations without position stops. A sensor, not shown, sends a signal to the transmission controller whenever the knob is rotated clockwise one detent position or rotated counter-clockwise one detent position (the signal indicates the direction of rotation). When the knob is rotated by more than one detent position, multiple such signals are sent. In response, the controller changes the currently selected drive mode, unless such as change is prohibited for some reason. For example, when the transmission is in park, a clockwise rotation is ignored unless the brake pedal is depressed. Although the driver is not prevented from moving the knob, the driver is still prevented from disengaging park. When the current drive mode is park, the controller ignores counter-clockwise rotation. When the current drive mode is low, the controller ignores clockwise rotation.

If the transmission controller engages park for a reason other than movement of the knob, for example in an autonomous vehicle or a controller's safety response, the change is indicated by illuminating the P shaped light 60. No additional hardware is required to synchronize the shift selector with the current transmission mode. Consequently, the transmission may shift from Park to Reverse in response to clockwise rotation of the knob from a first position to a second position. Then, the transmission may return to Park while the knob remains in the second position, for example in response to the driver opening the door with the seat belt unbuckled. Then, the transmission may shift from Park to Reverse in response to a clockwise rotation of the knob from a second position to a third position.

In alternative embodiments, the five discrete lights may be replaced with or supplemented by a single display, such as a video screen, which is programmed to display a different image for each transmission mode. For example, the image could be the letter traditionally associated with the transmission mode or an icon that graphically illustrates the mode. The screen may be physically near the knob or in another position visible to the driver such as the instrument cluster or a portion of a multi-function display.

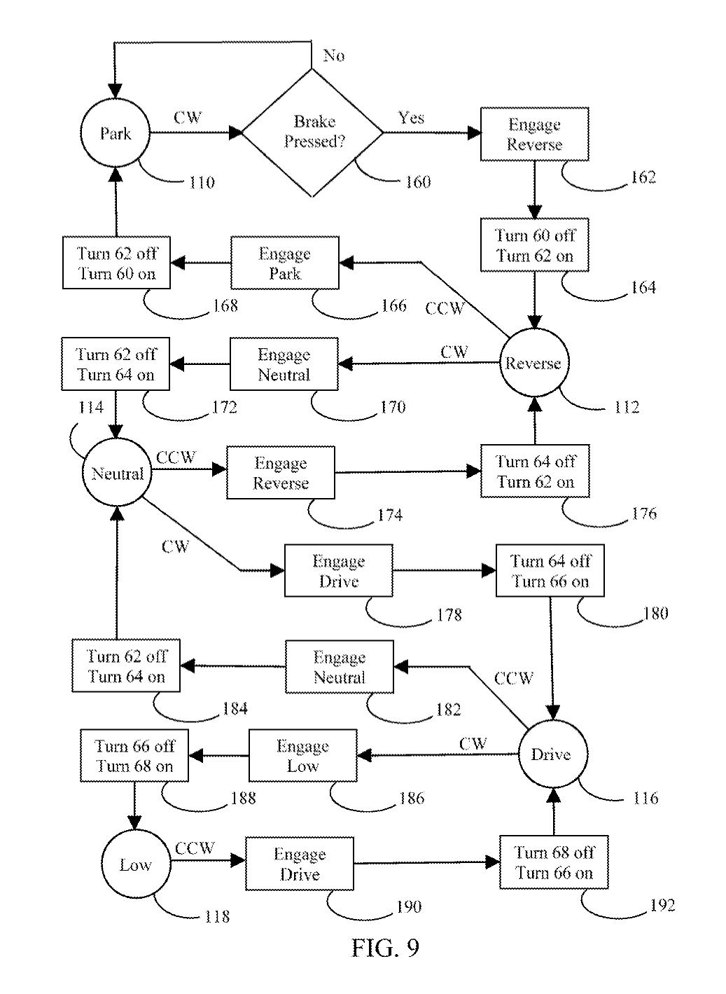

FIG. 9 is a flow chart for use of the shift selector of FIG. 8. In Park state 110, the controller responds to CW events by checking at 160 whether the brake pedal is pressed. If not, the controller remains in Park state 110. If the brake pedal is pressed, the controller engages reverse at 162, updates the LEDs at 164, and enters the Reverse state 112. The controller takes no action in response to a CCW event in Park state 110. From Reverse state 112, the controller responds to a CCW event by engaging park at 166, updating the LEDs at 168, and entering Park state 110. The controller responds to a CW event in Reverse state 112 by engaging neutral at 170, updating the LEDs at 172, and entering Neutral state 114. From Neutral state 114, the controller responds to a CCW event by engaging reverse at 174, updating the LEDs at 176, and entering Reverse state 112. The controller responds to a CW event in Neutral state 114 by engaging drive at 178, updating the LEDs at 180, and entering Drive state 116. From Drive state 116, the controller responds to a CCW event by engaging reverse at 182, updating the LEDs at 184, and entering Neutral state 114. The controller responds to a CW event in Drive state 116 by engaging drive at 186, updating the LEDs at 188, and entering Low state 118. From Low state 118, the controller responds to a CCW event by engaging drive at 190, updating the LEDs at 192, and entering Drive state 116. The controller does not respond to CW events in Low state 118.

The controller may execute the flow charts of FIGS. 3 and 9 simultaneously. With the shift selector of FIG. 8, the synchronization at 122 in FIG. 3 is accomplished by illuminating LED 60 and extinguishing the other LEDs. Knob 40″ is not physically rotated, so no motor is required.

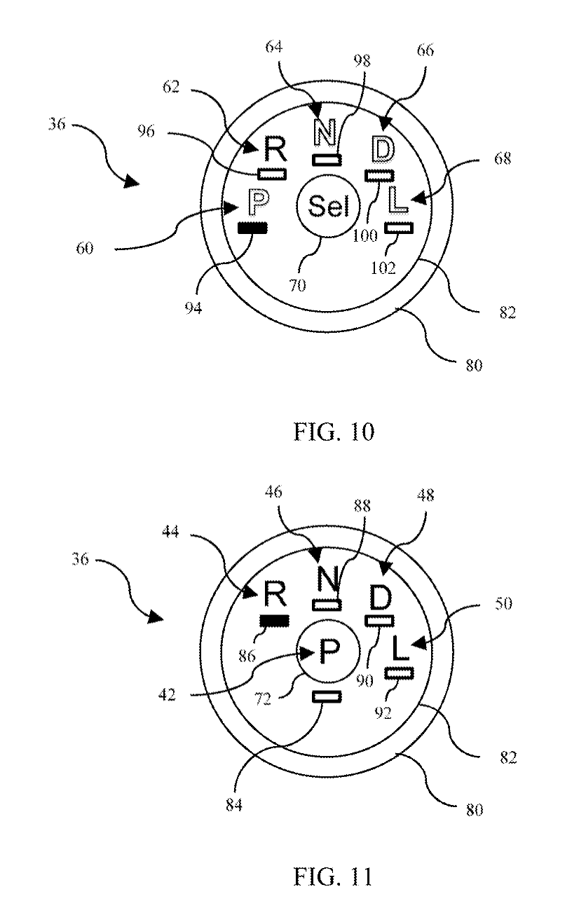

FIG. 10 illustrates a fifth shift selector which combines features of the shift selectors of FIGS. 4 and 8. Continuous rotary knob 80 is located within the drivers reach and vision such as on a dashboard. Letter shaped lights 60, 62, 64, 66, and 68 are fixed to a non-rotating surface 82 around which knob 80 rotates. The controller illuminates the letter corresponding to the currently selected transmission mode. Additionally, lights 94, 96, 98, 100, and 102 are placed near the letter shaped lights. The lights are illuminated to indicate which mode will be selected if the select button 70 is pressed. As in the selector of FIG. 4, activation of select button 70 is ignored if the requested shift is not allowed, such as if the brake pedal is not pressed when a shift from park is requested. The respective functions of the letter shaped lights 60-68 and the associated lights 94-102 may be reversed, or one of the functions may be accomplished by a separate display. After a preset time limit, such as 30 seconds, the controller may reset the pre-selected mode to correspond to the current (unchanged) mode and reset the indicator lights accordingly.

In an alternative embodiment of the shifter of FIG. 10, the select button is omitted. The controller waits a fixed interval, such as 500 ms, after the knob is rotated and then shifts to the selected mode if all appropriate pre-conditions are satisfied. If the pre-conditions are not satisfied, then the controller may reset the pre-selected mode to correspond to the current (unchanged) mode and reset the indicator lights accordingly.

FIG. 11 illustrates a sixth shift selector. Continuous rotary knob 80 is located within the drivers reach and vision such as on a dashboard. Letters 42, 44, 46, 48, and 50 are printed in fixed positions on non-rotating surface 82 around which knob 80 rotates. Indicator lights 86, 88, 90, 92, and 94 are placed near the letters. The indicator lights are illuminated to indicate the currently selected mode. Alternatively, the currently selected mode may be displayed using letter shaped lights or some other mechanism. Park button 72 is located in the center of knob 80 or adjacent to it.

When the transmission is in park and the brake pedal is pressed, the controller responds to clockwise rotation of knob 80 by shifting into drive. The controller responds to counter-clockwise rotation of knob 80, if the brake pedal is pressed, by shifting into revers. If the brake pedal is not depressed, rotation of the knob is ignored. In other words, when shifting out of park, the next mode is determined relative to neutral regardless of what mode was selected before entering park. To shift from park to neutral, the driver should either rotate the knob one notch in either direction and then rotate it back to its original position.

When the transmission is in a mode other than park, the controller responds to rotation of the knob by shifting among the non-park modes in the displayed order relative to the current mode. For example, if the current mode is drive, the controller shifts into neutral in response to a single counter-clockwise rotation and to low in response to a single clockwise rotation. If additional positions exist beyond the new position, the controller may wait a short time to determine if the driver will continue moving the knob to the next position so that only one shift is needed for a multiple position change. For example, when the transmission is in reverse and the driver moves the knob one step clockwise, the controller may wait a fraction of a second to see if the driver moves another step clockwise. If another clockwise step occurs in that interval, the controller shifts directly into drive. Otherwise, the controller shifts into neutral. If the shifter is in reverse and the knob is rotated counter clockwise, the transmission would remain in reverse. If the shifter is in low and the knob is turned clockwise, the transmission would remain in low. The transmission shifts into park in response to pressing the park button.

As with the selectors of FIGS. 4 and 6, the selectors of FIGS. 8, 10, and 11 do not require a knob brake or motor to implement a park-brake-interlock or auto-park feature.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, embodiments described as less desirable than other embodiments or prior art implementations with respect to one or more characteristics are not outside the scope of the disclosure and can be desirable for particular applications.

What is claimed is:

1. A vehicle comprising:
a transmission having a park mode and a reverse mode;
a rotary shift selector knob; and
a controller programmed to
shift from the park mode to the reverse mode in response to the knob being rotated from a first position to a second position, and
shift from the park mode to the reverse mode in response to the knob being rotated from the second position to a third position.

2. The vehicle of claim 1 wherein the controller is further programmed to shift from the reverse mode to the park mode without rotation of the knob.

3. The vehicle of claim 2 wherein the controller is programmed to shift from the reverse mode to the park mode in response to activation of a park button.

4. The vehicle of claim 1 wherein the controller is further programmed to shift from the park mode only when a brake pedal is pressed while the knob is rotated.

5. The vehicle of claim 1 wherein:
the knob has a plurality of detent positions including the first, second, and third positions; and
the knob is free to move among the detent positions without stops.

6. The vehicle of claim 1 further comprising a plurality of symbols in fixed positions around the knob, each corresponding to a transmission mode and configured to indicate whether the transmission is presently in the corresponding transmission mode.

7. A vehicle comprising:
a transmission having a reverse mode and a drive mode;
a rotary knob;
a select button; and
a controller programmed to
shift from the reverse mode to the drive mode in response to selection of drive with the knob followed by activation of the select button, and
shift from the drive mode to the reverse mode in response to selection of reverse with the knob followed by activation of the select button.

8. The vehicle of claim 7 wherein:
the knob has a reverse position and a drive position; and
selection of reverse and drive with the knob comprises rotating the knob to the reverse and drive positions respectively.

9. The vehicle of claim 7 wherein:
the knob has a plurality of detent position;
the knob is free to move among the detent positions without stops; and
selection of reverse and drive with the knob comprises rotating the knob until symbols corresponding to reverse and drive respectively are illuminated.

10. The vehicle of claim 7 wherein:
the transmission also has a park mode; and
the controller is further programmed to
shift from the reverse mode or drive mode to the park mode in response to selection of park with the knob followed by activation of the select button, and
shift from the park mode in response to activation of the select button while a brake pedal is pressed.

11. A vehicle comprising:
a transmission having park, reverse, neutral, and drive modes;
a continuous rotary shift selector knob having a plurality of detent positions without stops;
a plurality of symbols in fixed positions, each corresponding to a transmission mode and configured to indicate whether the transmission is presently in the corresponding transmission mode; and
a controller programmed to shift the transmission among the reverse, neutral, and drive modes in response to rotation of the knob.

12. The vehicle of claim 11 wherein the controller is programmed to shift the transmission from the reverse mode to the drive mode in response to rotation of the knob.

13. The vehicle of claim 12 wherein the controller is further programmed to shift the transmission from the park mode to the reverse mode in response to rotation of the knob in combination with depression of a brake pedal.

14. The vehicle of claim 12 wherein the controller waits to shift the transmission among the park, reverse, neutral, and drive modes until a select button is pressed.

15. The vehicle of claim 14 wherein the symbols are further configured to indicate which transmission mode would be selected if the select button is pressed.

16. The vehicle of claim 11 further comprising a park button and wherein the controller is further programmed to shift the transmission from the reverse, neutral, or drive modes to the park mode in response to depression of the park button.

17. The vehicle of claim 11 wherein the controller is further programmed to shift the transmission from the park mode to the drive mode in response to clockwise rotation of the knob with a brake pedal depressed.

18. The vehicle of claim 17 wherein the controller is further programmed to shift the transmission from the park mode to the reverse mode in response to counter-clockwise rotation of the knob with a brake pedal depressed.
